(19) United States
(12) Patent Application Publication
(10) Pub. No.: US 2017/0363783 A1
(43) Pub. Date: Dec. 21, 2017

(54) RETROREFLECTIVE ELEMENTS WITH A MONOLAYER-FORMING COMPOUND

(71) Applicant: 3M Innovative Properties Company, St. Paul, MN (US)

(72) Inventor: James E. GARBE, Stillwater, MN (US)

(21) Appl. No.: 15/527,303

(22) PCT Filed: Dec. 4, 2015
(86) PCT No.: PCT/US2015/064007

§ 371 Date: May 16, 2017

Related U.S. Application Data
(60) Provisional application No. 62/087,959, filed on Dec. 5, 2014.

(51) Int. Cl. G02B 5/128; G02B 1/04; C09D 5/33

(52) U.S. Cl. CPC G02B 5/128; C09D 5/004; G02B 1/04

(57) ABSTRACT

The present disclosure generally relates to retroreflective elements having a mono-layer forming compound, articles (including, for example, retroreflective roadway paints) including these retroreflective elements, and methods of making and using these retroreflective elements. Some embodiments relate to a retroreflective element, comprising: a core; a plurality of glass beads adjacent to the core; and a monolayer-forming organic compound.

### TECHNICAL FIELD

The present disclosure generally relates to retroreflective elements having a mono-layer forming compound, articles (including, for example, retroreflective roadway paints) including these retroreflective elements, and methods of making and using these retroreflective elements.

### BACKGROUND

Retroreflective paints typically include retroreflective elements. Such retroreflective elements are described in, for example, U.S. Pat. Nos. 5,750,191; 5,774,265; 5,942,280; 7,513,941; 8,591,044; 8,591,045; and U.S. Patent Publication Nos. 2005/0100709 and 2005/0158461, all of which are incorporated herein in their entirety. Commercially available retroreflective elements include, for example. All Weather Elements made by 3M Company of St. Paul, Minn. An exemplary retroreflective element is shown in FIG. 1. Retroreflective element 100 includes a core 110 adjacent to numerous glass beads 120 that are adhered to the outermost surface of core 110 by a binder.

As is described in, for example, U.S. Patent Publication No. 2005/0100709, the retroreflective elements are applied onto or into roadway marking paint such that at least a portion of most of the retroreflective elements extends above or out of the roadway marking paint. Light that is transmitted by a light source (e.g., a streetlight or a car's headlights) is incident on the roadway marking paint (and the retroreflective elements therein) is retroreflected by the retroreflective elements in the roadway making paint. Specifically, the glass beads transmit incident light back toward the incoming light source.

### SUMMARY

The inventors of the present disclosure recognized that many roadway marking paints completely cover or wick around the retroreflective elements added onto or into the roadway marking paint. This is especially true for roadway marking paints including epoxy. When the roadway marking paint wicks around or covers all or significant portions of the retroreflective elements, the glass beads are no longer able to retroreflect incident light and the effectiveness of the roadway marking paints significantly decreases.

As such, the inventors of the present disclosure discovered that, unexpectedly, treatment of the retroreflective elements with a monolayer-forming organic compound reduces the incidence of the roadway marking paint wicking up or covering the retroreflective elements.

Some embodiments of the present application relate to a retroreflective element, comprising: a core; a plurality of glass beads adjacent to the core; and a monolayer-forming organic compound. In some embodiments, the monolayer-forming organic compound includes a polar head group and a non-polar tail. In some embodiments, the monolayer has a molecular weight of between about 200 and about 1000. In some embodiments, the monolayer-forming organic compound is a fluorinated phosphonic acid compound. In some embodiments, the monolayer-forming organic compound has at least one of the following structures:

R₁—Z—(CH₂)ₙ-Q I

R₁—Z—(CH₂)ₙ—N⁺R₂R₃R₄ X⁻ II

R₁—Z—(CH₂)ₙ—Y⁻ M⁺ III

wherein R₁ is an oleophobic group having at least one carbon atom; wherein Z is a divalent linking group; wherein n is an integer greater than zero; wherein Q is an unionized group; wherein R₂, R₃, and R₄ are one of a hydrogen or an alkyl group having between one and eight carbon atoms; wherein X is a monovalent anion; wherein Y is an anionic group; and wherein M is a monovalent cation. In some embodiments, R₁ is at least partially fluorinated. In some embodiments, R₁ includes at least one of methyl, ethyl, n-butyl, isobutyl, tert-butyl, phenyl, benzyl, cyclohexyl, cyclohexylmethyl, and pentafluorophenyl. In some embodiments, Z includes at least one of alkylene, arylene, oxy, or thio group. In some embodiments, Q includes an acidic group or a basic group.

In some embodiments, the acidic group includes at least one of a carboxylic, a phosphonic, a phosphinic, a sulfonic, or a sulfinic acid group. In some embodiments, the basic group includes at least one of a hydroxyl, a mercapto, an ether, or a thioether group. In some embodiments, wherein X includes at least one of a halide or a pseudohalide. In some embodiments, Y includes at least one of a carboxylate, a sulfate, a sulfonate, a phosphate, a phosphonate, an alcoholate, a thiolate, a 2,4-pentanedione moiety, or a beta ketoester. In some embodiments, M includes an alkali metal cation or an ammonium ion. In some embodiments, if R¹ is an unsubstituted straight chain alkylene group, then the sum of carbon atoms in R₁ and R₂ combined is at least 10. In some embodiments, R₂ is a perfluoro-n-butyl group.

In some embodiments, the monolayer-forming organic compound self-assembles. In some embodiments, the core is at least one of a sand core, sand, glass, polymer, or ceramic. In some embodiments, the glass beads have a refractive index of between 1.8 and 2.3. In some embodiments, the monolayer-forming organic compound is unimolecular. In some embodiments, the monolayer-forming organic compound is solid at 25° C.

Some other embodiments relate to a retroreflective element, comprising: a core; a plurality of glass beads adjacent to the core; and a monolayer-forming organic compound; wherein the monolayer-forming organic compound has the formula:

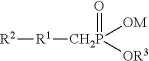

wherein: R₁ is a straight chain alkylene group having from 7 to 21 carbon atoms, wherein a methylene moiety may be replaced by an oxygen atom at a single site, or at multiple sites along the methylene chain; R₂ is a perfluoroalkyl group having from 4 to 10 carbon atoms; R₃ is hydrogen, an alkali metal cation, or an alkyl group having from 1 to 6 carbon atoms; and M is hydrogen or an alkali metal cation.

In some embodiments, the monolayer has a molecular weight of between about 200 and about 1000. In some embodiments, the monolayer-forming organic compound self-assembles. In some embodiments, the core is at least one of a sand core, sand, glass, polymer, or ceramic. In some embodiments, the glass beads have a refractive index of between 1.8 and 2.3. In some embodiments, the monolayer-forming organic compound is unimolecular. In some embodiments, the monolayer-forming organic compound is solid at 25° C.

Some embodiments relate to a liquid pavement marking composition including the retroreflective elements as described in any of the embodiments above. In some embodiments, the liquid pavement marking composition further includes a retroreflective element embedment composition. In some embodiments, the retroreflective element embedment composition includes an epoxy. In some embodiments, the monolayer at least assists in imparting a low energy retroreflective element surface.

Some embodiments relate to a method of forming a retroreflective element, comprising: providing an untreated retroreflective element including a core and a plurality of glass beads adjacent to the core; and contacting the untreated retroreflective element with a monolayer-forming organic compound to form the retroreflective element. In some embodiments, the method further comprises drying the retroreflective element. In some embodiments, the method further comprises separating the retroreflective elements from the monolayer-forming organic compound. In some embodiments, the monolayer-forming organic compound includes at least one of water, an aliphatic alcohol, and alkoxy alcohol, a water-miscible alcohol, a water-miscible ketone, or a water-miscible ester. In some embodiments, the monolayer-forming organic compound has a concentration of between about 50 ppm (0.005 wt %) to about 5000 ppm (0.5 wt %) based on the weight of the untreated retroreflective elements. In some embodiments, the monolayer-forming organic compound includes at least one of sulfamic acid, citric acid, phosphoric acid, an alkali earth metal hydroxide, an alkaline earth metal hydroxide, an amine-containing compound, or a chelating agent. In some embodiments, the method further comprises including a retroreflective element embedment composition. In some embodiments, the retroreflective element embedment composition is the composition of any of the embodiments described herein. In some embodiments, the retroreflective elements are any of the retroreflective elements described herein.

### BRIEF DESCRIPTION OF DRAWINGS

FIG. 1 is a schematic drawing of a prior art retroreflective element.

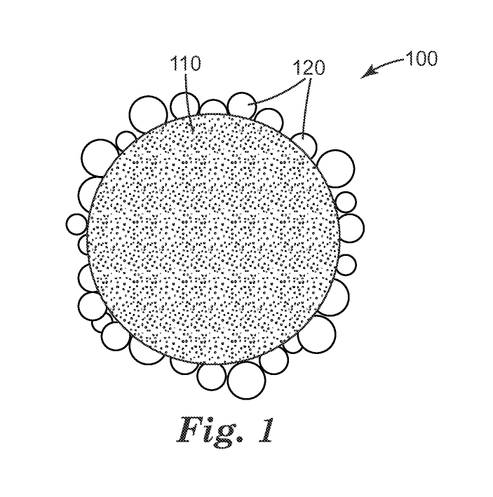

### DETAILED DESCRIPTION

Various embodiments and implementations will be described in detail. These embodiments should not be construed as limiting the scope of the present disclosure in any manner, and changes and modifications may be made without departing from the spirit and scope of the inventions. Further, only some end uses have been discussed herein, but end uses not specifically described herein are included within the scope of the present disclosure. As such, the scope of the present disclosure should be determined only by the claims.

The term “retroreflective” as used herein refers to the attribute of reflecting an obliquely incident radiation ray in a direction generally antiparallel to its incident direction such that it returns to the radiation source or the immediate vicinity thereof.

The present disclosure generally relates to a retroreflective element including (1) a core; (2) a plurality of glass beads adjacent to the core; and (3) a monolayer-forming organic compound. The retroreflective elements described herein have improved embedment properties in liquid pavement marking compositions, particularly epoxy pavement markings. Specifically, roadway marking paint including retroreflective elements of the type described herein exhibits desirable, lower embedment in liquid roadway or pavement markings, especially those including epoxy. Without being limited by theory, it is believed that the monolayer-forming organic compound assists in moderating the embedment of the retroreflective elements in the paint or paint components of roadway marking paint. Because the beneficial effects of these retroreflective elements can be achieved with relatively low weight ratios of monolayer-forming compound, this is a cost-effective method of increasing roadway marking paint optical performance and durability.

Additionally, because the optical performance of the roadway marking paint is increased, the roadway making paint can remain on the roadway longer, reducing the incidence of roadway closure for paint application as well as expense of roadway upkeep.

Also, because the monolayer-forming compound of the present disclosure is low cost and provides the beneficial optical and durability effects at low concentration, manufacturing cost of an excellent roadway marking paint and of the retroreflective elements capable of inclusion therein is lowered.

### Core

The core can include, for example, glass, ceramic, polymer, or an oxide such as silicon dioxide. Some exemplary cores are described in, for example, U.S. Pat. Nos. 5,774,265; 5,942,280; and 7,513,941, all of which are incorporated herein in their entirety. One exemplary type of core is a sand core, which is described generally in U.S. Patent Publication No. 2005/0100709, incorporated herein in its entirety. In some embodiments, the core is at least one of a sand core, sand, glass, polymer, or ceramic.

### Glass Beads:

Any existing retroreflective element glass beads can be used in the retroreflective elements of the present application. This includes, for example, those glass beads described in U.S. Pat. Nos. 3,493,403; 3,709,706; 4,564,556; and 6,245,700, all of which are incorporated herein in their entirety.

In some embodiments, the glass beads have mean or average diameters of 30-100 microns. In some embodiments, the glass beads have mean or average diameters of 60-80 microns.

In some embodiments, the glass beads have refractive indices of between about 1.8 and about 2.3. In some embodiments, the glass beads have a mean refractive index of between about 1.8 and about 2.3. In some embodiments, the glass beads have a refractive index of between about 1.9 and about 2.2. In some embodiments, the glass beads have a refractive index of about 1.9. In some embodiments, the glass beads have a refractive index of about 2.2.

Some exemplary glass compositions include those described, for example, in U.S. Pat. Nos. 6,245,700 and 7,524,779, both of which are incorporated herein in their entirety. In some embodiments, the glass beads include at least one or more of, for example, a lanthanide series oxide, aluminum oxide, TiO₂, BaO, SiO₂, or ZrO₂.

In some embodiments, the core and glass beads are in a bonded core element construction. Examples of commercially available constructions of this type include, for example, All Weather Elements made by 3M Company of St. Paul, Minn. and Reflective Elements made by 3M Company.

### Monolayer-Forming Organic Compound:

The monolayer-forming compound of the present disclosure is preferably organic. In some embodiments, the monolayer has a molecular weight of between about 200 and about 1000. In some embodiments, the monolayer-forming organic compound includes a polar head group and a non-polar tail. In some embodiments, the monolayer-forming organic compound is a fluorinated phosphonic acid compound. In some embodiments, the monolayer-forming organic compound includes at least one of sulfamic acid, citric acid, phosphoric acid, an alkali earth metal hydroxide, an alkaline earth metal hydroxide, an amine-containing compound, or a chelating agent.

In some embodiments, the monolayer-forming organic compound has at least one of the following structures:

R₁—Z—(CH₂)ₙ-Q I

R₁—Z—(CH₂)ₙ—N⁺R₂R₃R₄ X⁻ II

or

R₁—Z—(CH₂)ₙ—Y⁻ M⁺ III

wherein R₁ is an oleophobic group having at least one carbon atom;

wherein Z is a divalent linking group;

wherein n is an integer greater than zero;

wherein Q is an unionized group;

wherein R₂, R₃, and R₄ are one of a hydrogen or an alkyl group having between one and eight carbon atoms;

wherein X is a monovalent anion;

wherein Y is an anionic group; and

wherein M is a monovalent cation.

In some embodiments, R₁ is at least partially fluorinated. In some embodiments, R₁ includes at least one of methyl, ethyl, n-butyl, isobutyl, tert-butyl, phenyl, benzyl, cyclohexyl, cyclohexylmethyl, and pentafluorophenyl. In some embodiments, Z includes at least one of alkylene, arylene, oxy, or thio group. In some embodiments, Q includes an acidic group or a basic group. In some embodiments, the acidic group includes at least one of a carboxylic, a phosphonic, a phosphinic, a sulfonic, or a sulfinic acid group. In some embodiments, the basic group includes at least one of a hydroxyl, a mercapto, an ether, or a thioether group. In some embodiments, X includes at least one of a halide or a pseudohalide. In some embodiments, Y includes at least one of a carboxylate, a sulfate, a sulfonate, a phosphate, a phosphonate, an alcoholate, a thiolate, a 2,4-pentanedione moiety, or a beta ketoester. In some embodiments, M includes an alkali metal cation or an ammonium ion.

Some other embodiments relate to a retroreflective element, comprising: a core; a plurality of glass beads adjacent to the core; and a monolayer-forming organic compound; wherein the monolayer-forming organic compound has the formula:

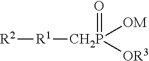

wherein: R₁ is a straight chain alkylene group having from 7 to 21 carbon atoms, wherein a methylene moiety may be replaced by an oxygen atom at a single site, or at multiple sites along the methylene chain; R₂ is a perfluoroalkyl group having from 4 to 10 carbon atoms; R₃ is hydrogen, an alkali metal cation, or an alkyl group having from 1 to 6 carbon atoms; and M is hydrogen or an alkali metal cation.

In some embodiments, the monolayer-forming compound self assembles. Self-assembling materials, as their name implies, spontaneously form a structure (e.g., micelle or monolayer) when they contact another substance. Monolayer formation may be particularly useful when it occurs on the surface of a solid substrate (e.g., a piece of metal). If a monolayer is formed from a material that imparts a low surface energy to a surface of a substrate, then one or more useful properties such as water repellency, corrosion resistance, lubricity, and adhesive release may be imparted to that surface. If the surface energy is low enough, oil repellency and soil (i.e., stain) resistance may be achieved.

In some embodiments, the monolayer-forming compound is unimolecular. As used herein, the term “unimolecular” means non-polymeric.

In some embodiments, the monolayer-forming organic compound is solid at 25° C.

In some embodiments, the resulting retroreflective elements have a mean or average diameter of between about 100 microns and about 2000 microns.

In some embodiments, the retroreflective elements are essentially spherical, as described in, for example, U.S. Pat. Nos. 5,942,280 and 7,513,941, both of which are incorporated herein in their entirety. In some embodiments, the retroreflective elements are non-spherical, as described in, for example, U.S. Pat. No. 5,774,265, incorporated by reference herein in its entirety.

The retroreflective elements can have any desired topography. For example, the elements can be roughly spherical overall, with an outer surface of closely packed glass beads. In some embodiments, the glass beads are generally spherical. Regardless of the shape of the element, one preferred surface topography is close packed, which assists in maximizing retroreflectivity (brightness).

### Methods of Making

The retroreflective elements described herein can be made, manufactured, or formed by any of several methods. In one exemplary embodiment, a plurality of structures including the core and glass beads are combined with the monolayer-forming compound. The mixture can then be agitated by shaking or stirring, or in, for example, a fluidized bed.

In some embodiments, the method of making the retroreflective elements described herein involves providing an untreated retroreflective element including a core and a plurality of glass beads adjacent to the core; and contacting the untreated retroreflective element with a monolayer-forming organic compound to form the retroreflective element. In some embodiments, the method further involves drying the retroreflective element. In some embodiments, the method involves separating the retroreflective elements from the monolayer-forming organic compound. In some embodiments, the monolayer-forming organic compound includes at least one of water, an aliphatic alcohol, and alkoxy alcohol, a water-miscible alcohol, a water-miscible ketone, or a water-miscible ester. In some embodiments, the monolayer-forming organic compound has a concentration of between about 50 ppm (0.005 wt %) to about 5000 ppm (0.5 wt %) based on the weight of the untreated retroreflective elements. In some embodiments, the monolayer-forming organic compound includes at least one of sulfamic acid, citric acid, phosphoric acid, an alkali earth metal hydroxide, an alkaline earth metal hydroxide, an amine-containing compound, or a chelating agent.

### Roadway Marking Paint

The present disclosure also relates to both roadway marking paint including the retroreflective elements described herein and to methods of making and using the roadway marking paint. Any known roadway marking paint can be used with the retroreflective elements described herein. Some exemplary commercially available roadway marking paints capable of use with the retroreflective elements include, for example, Liquid Pavement Marking Series 5000, available from 3M Company, St. Paul, Minn.; HPS-2, available from Ennis-Flint, Thomasville, N.C.; and LS90, available from Epoplex, Maple Shade, N.J. In some embodiments, the roadway making paint includes a colorant. In some embodiments, the roadway marking paint is white or yellow.

Any known process for including or applying retroreflective elements to roadway making paint may be used to include or apply the retroreflective elements described herein to roadway marking paint. For example, the methods described in the following patents may be used: U.S. Pat. Nos. 3,935,158, 4,203,878, and 5,774,265, all of which are incorporated herein in their entirety herein.

Objects and advantages of the present disclosure are further illustrated by the following examples, but the particular materials and amounts thereof recited in the examples, as well as other conditions and details, should not be construed to unduly limit the scope of the application, as those of skill in the art will recognize that other parameters, materials, and equipment may be used. All parts, percentages and ratios herein are by weight unless otherwise specified.

### EXAMPLES

Structures including a core and glass beads (“core/bead structures”) that were used to prepare the retroreflective elements of the present disclosure were prepared as described in Example 1 of U.S. Patent Publication No. 20050158461, incorporated herein in its entirety.

A partially fluorinated phosphonic acid having a formula of C₄F₉(CH₂)₁₁PO₃H₂ was prepared as described in U.S. Pat. No. 6,824,882 (Boardman et al.), incorporated herein in its entirety.

All Weather Elements Series 50E refers to retroreflective elements for application on liquid epoxy pavement marking compositions, available from 3M Company, St. Paul, Minn.

“HPS-2” refers to a 2-part liquid epoxy pavement marking composition available from Ennis-Flint, Thomasville, N.C.

### Examples 1-4

Preparation of Retroreflective Elements with Monolayer-Forming Treatment

A 0.1 weight percent ethanol solution of the partially fluorinated phosphonic acid of Formula IV was prepared by dissolving 0.1 g of the acid in 99.9 g of absolute ethanol. In each of Examples 1-3, 25 g of core/bead structures were combined in a beaker at room temperature with an amount (by weight) of this treatment solution, as shown below in Table 1, to provide the desired treatment level, expressed in Table 1, as weight parts per million. In Example 4, 25 g of core/bead structures were combined in a beaker at room temperature with the amount (by weight) of the treatment solution shown in Table 1 that was first diluted with 1.75 g of absolute ethanol. The structures were stirred using a large spoon or spatula as the solution was added to the beaker via pipet in several portions. After the addition was complete each mixture was stirred for an additional 1 minute, and then a heat gun was used to direct warm air into the beaker to evaporate the ethanol until each of the materials was essentially free-flowing. Each of the materials was then transferred to an aluminum pan and were further dried in an oven at 60° C. for 15 minutes and then at 75° C. for 10 minutes.

TABLE 1
Examples 1-4

| | Wt. Treatment | | Treatment | |
|---|---|---|---|---|
| Example | Solution | | Level | |
| 1 | 10 | gms | 400 | ppm |
| 2 | 5 | gms | 200 | ppm |
| 3 | 2.5 | gms | 100 | ppm |
| 4 | 1.25 | gms | 50 | ppm |

### Example 5

Alternative Preparation of Retroreflective Elements with Monolayer-Forming Treatment

The core/bead structures (25 g) were stirred for 1 minute in a beaker with 4 g of a 0.1 weight percent ethanol solution of the phosphonic acid of Formula IV. The wet structures were removed from the beaker, leaving excess solution in the beaker. The structures were then dried as described in Examples 1-4.

### Examples 6-10

Each of the retroreflective elements of Examples 1-5 were evaluated in Examples 6-10, respectively. A white liquid epoxy pavement marking composition (HPS-2; Ennis-Flint, Thomasville, N.C.) was coated onto 5 aluminum panels using a notched coating bar at 0.030.” Immediately after coating the epoxy on the panels, the treated elements of Examples 1-5 were sprinkled onto the uncured coating on each of the separate panels of Examples 6-10.

### Comparative Example A

To form Comparative Example A, the core/bead structure was sprinkled onto uncured HPS-2. The degree of embedment of the elements in the epoxy was visually assessed at least 3 hours after coating, to allow time for substantial curing of the epoxy.

The degree of element embedment in all of the Example 6-10 panels (all of which included treated elements) visually appeared to be substantially less than the degree of embedment of the panel of Comparative Example A (whose elements were not treated).

All references mentioned herein are incorporated by reference in their entirety.

Unless otherwise indicated, all numbers expressing feature sizes, amounts, and physical properties used in the present disclosure and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this disclosure and the appended claims, the term “or” is generally employed in its sense including “and/or” unless the content clearly dictates otherwise.

Various embodiments and implementation of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments and implementations other than those disclosed. Those having skill in the art will appreciate that many changes may be made to the details of the above-described embodiments and implementations without departing from the underlying principles thereof. It should be understood that this invention is not intended to be unduly limited by the illustrative embodiments and examples set forth herein and that such examples and embodiments are presented by way of example only with the scope of the invention intended to be limited only by the claims set forth herein as follows. Further, various modifications and alterations of the present invention will become apparent to those skilled in the art without departing from the spirit and scope of the present disclosure. The scope of the present application should, therefore, be determined only by the following claims.

1-43. (canceled)

44. A retroreflective element, comprising:
a core;
a plurality of glass beads adjacent to the core; and
a monolayer-forming organic compound.

45. The retroreflective element of claim 44, wherein the monolayer-forming organic compound includes a polar head group and a non-polar tail.

46. The retroreflective element of claim 44, wherein the monolayer-forming organic compound is a fluorinated phosphonic acid compound.

47. The retroreflective element of claim 44, wherein the monolayer-forming organic compound has at least one of the following structures:
R₁—Z—(CH₂)ₙ-Q I
or
R₁—Z—(CH₂)ₙ—N⁺R₂R₃R₄ X⁻ II
or
R₁—Z—(CH₂)ₙ—Y⁻ M⁺ III
wherein R₁ is an oleophobic group having at least one carbon atom;
wherein Z is a divalent linking group;
wherein n is an integer greater than zero;
wherein Q is an unionized group;
wherein R₂, R₃, and R₄ are one of a hydrogen or an alkyl group having between one and eight carbon atoms;
wherein X is a monovalent anion;
wherein Y is an anionic group; and
wherein M is a monovalent cation.

48. The retroreflective element of claim 47, wherein R₁ is at least partially fluorinated.

49. The retroreflective element of claim 47, wherein R₁ includes at least one of methyl, ethyl, n-butyl, isobutyl, tert-butyl, phenyl, benzyl, cyclohexyl, cyclohexylmethyl, and pentafluorophenyl.

50. The retroreflective element of claim 47, wherein Z includes at least one of alkylene, arylene, oxy, or thio group.

51. The retroreflective element of claim 47, wherein Q includes an acidic group or a basic group.

52. The retroreflective element of claim 51, wherein the acidic group includes at least one of a carboxylic, a phosphonic, a phosphinic, a sulfonic, or a sulfinic acid group.

53. The retroreflective element of claim 51, wherein the basic group includes at least one of a hydroxyl, a mercapto, an ether, or a thioether group.

54. The retroreflective element of claim 47, wherein X includes at least one of a halide or a pseudohalide.

55. The retroreflective element of claim 47, wherein Y includes at least one of a carboxylate, a sulfate, a sulfonate, a phosphate, a phosphonate, an alcoholate, a thiolate, a 2,4-pentanedione moiety, or a beta ketoester.

56. The retroreflective element of claim 47, wherein M includes an alkali metal cation or an ammonium ion.

57. The retroreflective element of claim 47, wherein if R₁ is an unsubstituted straight chain alkylene group, then the sum of carbon atoms in R₁ and R₂ combined is at least 10.

58. The retroreflective element of claim 47, wherein R₂ is a perfluoro-n-butyl group.

59. The retroreflective element of claim 44, wherein the core is at least one of a sand core, sand, glass, polymer, or ceramic.

60. The retroreflective element of claim 44, wherein the monolayer-forming compound is C₄F₉(CH₂)₁₁PO₃H₂.

61. A liquid pavement marking composition including the retroreflective elements of claim 44.

62. A retroreflective element, comprising:
a core;
a plurality of glass beads adjacent to the core; and
a monolayer-forming organic compound;
wherein the monolayer-forming organic compound has the formula: 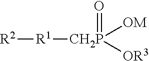
wherein:
R₁ is a straight chain alkylene group having from 7 to 21 carbon atoms, wherein a methylene moiety may be replaced by an oxygen atom at a single site, or at multiple sites along the methylene chain;
R₂ is a perfluoroalkyl group having from 4 to 10 carbon atoms;
R₃ is hydrogen, an alkali metal cation, or an alkyl group having from 1 to 6 carbon atoms; and
M is hydrogen or an alkali metal cation.

63. A liquid pavement marking composition including the retroreflective elements of claim 62.
